(19) United States
(12) Patent Application Publication
(10) Pub. No.: US 2021/0034790 A1
(43) Pub. Date: Feb. 4, 2021

(54) LIGHTWEIGHT ENCRYPTION AND ANONYMOUS ROUTING IN NoC BASED SoCs

(71) Applicant: University of Florida Research Foundation, Inc., Gainesville, FL (US)

(72) Inventors: Thelijjagoda S N Charles, Gainesville, FL (US); Prabhat Kumar Mishra, Gainesville, FL (US)

(21) Appl. No.: 16/937,882

(22) Filed: Jul. 24, 2020

Related U.S. Application Data
(60) Provisional application No. 62/879,657, filed on Jul. 29, 2019.

(51) Int. Cl. G06F 21/75; H04L 9/30

(52) U.S. Cl. CPC G06F 21/75; H04L 2209/12; H04L 9/30

(57) ABSTRACT

Various examples are provided related to software and hardware architectures that enable lightweight encryption and anonymous routing in a network-on-chip (NoC) based system-on-chip (SoC). In one example, among others, method for lightweight encryption and anonymous routing includes identifying, by a source node in a network-on-chip (NoC) based system-on-chip (SoC) architecture, a routing path from the source node to a destination node in the NoC-based SoC architecture, where the routing path comprises the source node, a plurality of intermediate nodes in the NoC-based SoC architecture, and the destination node; generating, by the source node, a plurality of tuples, a number of tuples in the plurality of tuples being based on a threshold; and distributing, by the source node, the plurality of tuples to the plurality of intermediate nodes and the destination node.

### CROSS-REFERENCE TO RELATED APPLICATIONS

This application claims priority to, and the benefit of, co-pending U.S. provisional application entitled “Lightweight Encryption and Anonymous Routing in NoC based SoCs” having Ser. No. 62/879,657, filed Jul. 29, 2019, which is hereby incorporated by reference in its entirety.

### STATEMENT REGARDING FEDERALLY SPONSORED RESEARCH OR DEVELOPMENT

This invention was made with government support under Award Number 1526687 and Award Number 1936040 awarded by the National Science Foundation. The government has certain rights in the invention.

### BACKGROUND

Advances in manufacturing technologies have enabled System-on-Chip (SoC) designers to integrate an increasing number of cores on a single SoC. Increasing SoC complexity, coupled with reduced time-to-market constraint, has led to increased utilization of Intellectual Property (IP) cores from third-party vendors. The SoC supply chain is widely acknowledged as a major source of security vulnerabilities. Potentially malicious third-party IPs integrated on the same Network-on-Chip (NoC) with the trusted components can lead to security and trust concerns. While secure communication is a well-studied problem in the computer networks domain, it is not feasible to implement those solutions on the resource constrained SoCs.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a System-on-Chip (SoC) architecture with intellectual property (IP) cores integrated into a mesh Network-on-Chip (NoC), in accordance with various embodiments of the present disclosure.

FIGS. 2A and 2B illustrate examples of a delay and execution time comparison for NoCs across different levels of network security, in accordance with various embodiments of the present disclosure.

FIGS. 3A-3B illustrate examples of several steps of lightweight encryption and anonymous routing in NoC-based SoCs, in accordance with various embodiments of the present disclosure.

FIG. 4 illustrates an example of an arrangement of several nodes of an NoC-based SoC that can be used to implement lightweight encryption and anonymous routing in NoC-based SoCs, in accordance with various embodiments of the present disclosure.

FIG. 5 illustrates an example of a route discovery phase of lightweight encryption and anonymous routing in NoC-based SoCs, in accordance with various embodiments of the present disclosure.

FIG. 6 illustrates an example of the Lagrangian polynomials L(x) and L′(x) used in lightweight encryption and anonymous routing in NoC-based SoCs together with the exemplary points on L(x) and L′(x), in accordance with various embodiments of the present disclosure.

FIG. 7 illustrates an example of a data transfer phase of lightweight encryption and anonymous routing in NoC-based SoCs, in accordance with various embodiments of the present disclosure.

FIG. 8 illustrates an example of an 8×8 mesh NoC architecture that includes trusted nodes running tasks and communicating with memory controllers and untrusted nodes that may have malicious IPs, in accordance with various embodiments of the present disclosure.

FIGS. 9A and 9B illustrate examples of a delay and execution time comparison using real benchmarks for NoCs using different levels of network security, including lightweight encryption and anonymous routing in NoC-based SoCs, in accordance with various embodiments of the present disclosure.

FIG. 10 illustrates an example of a delay comparison for NoCs using synthetic traffic patterns across different levels of network security, including lightweight encryption and anonymous routing in NoC-based SoCs, in accordance with various embodiments of the present disclosure.

### DETAILED DESCRIPTION

Disclosed herein are various examples related to software and hardware architectures that enable lightweight encryption and anonymous routing for communication between IP cores in Network-on-Chip (NoC) based Systems-on-Chip (SoC). The growth of general purpose as well as embedded computing devices has been remarkable over the past decade. This growth was mainly enabled by the advances in manufacturing technologies that allowed the integration of many heterogeneous components on a single System-on-Chip (SoC). The tight time-to-market deadlines and increasing complexity of modern SoCs have led manufacturers to outsource intellectual property (IP) cores from potentially untrusted third-party vendors.

Therefore, the trusted computing base of the SoC should exclude the third-party IPs. In fact, security measures should be taken since malicious third-party IPs can launch passive and active attacks on an SoC. Such attacks are possible primarily because the on-chip interconnection network that connects SoC components together—popularly known as Network-on-Chip (NoC)—has visibility of the entire SoC and the communications between IP cores. When designing an IP, a third-party vendor can insert a hardware Trojan in a router that can duplicate packets transferred through its ports and leak data to a malicious IP running a program that can send commands to the hardware Trojan and compromise the security of data included in those packets.

Conventional computer networks implement security methods like encryption and anonymous routing to protect against threats. For example, a symmetric encryption scheme can use the same key K for both decryption and encryption. An encryption algorithm E can produce a ciphertext C by taking a key K and a plaintext message M as inputs, which is denoted by C←E_{K}(M). Likewise, a decryption algorithm D can take a key K and a ciphertext C a return a corresponding message M, which is denoted by M←D_{K}(C). The correctness of the scheme is confirmed when any sequence of messages M₁, . . . , Mᵤ encrypted using a given key K produces C₁←E_{K}(M₁), C₂←E_{K}(M₂), . . . , Cᵤ←E_{K}(Mᵤ), and is related as D_{K}(Cᵢ)=Mᵢ for each Cᵢ.

In an asymmetric encryption scheme, also known as public key encryption, different keys can be used for encryption and decryption. Encryption can be done using a public key that is publicly known by all the entities in the environment. An entity B that wants to send a message M to another entity A that has public key PK_{A} can encrypt the message using A's public key to produce ciphertext C, which is denoted by C←E_{PK}_{_{A}}(M). The ciphertext can only be decrypted using a private key SK_{A} corresponding to PK_{A}. SK_{A} is known by only A, and therefore only A can decrypt C to produce M, which is denoted by M←D_{SK}_{_{A}}(C).

Onion routing is widely used in the domain of computer networks when routing has to be done while keeping the sender anonymous. In onion routing, each message is encrypted several times (layers of encryption) analogous to layers of an onion. Each intermediate router from source to destination (called onion routers) “peels” a single layer of encryption to reveal the next hop. The final layer is decrypted, and the message is read at the destination. The identity of the sender is preserved since each intermediate router only knows the preceding and the following routers.

Unfortunately, it is not feasible to implement well-known security solutions from computer networks on resource constrained SoCs in embedded systems and IoT devices. In particular, these security solutions can lead to unacceptable performance overhead. For example, the overhead of onion routing comes from the fact that the sender has to do several rounds of encryption before sending the packet to the network and each intermediate router has to do a round of decryption before forwarding it to the next hop. While onion routing can be implemented practically in computer networks, implementing onion routing in resource constrained NoCs can lead to unacceptable performance overhead.

Thus, it is not feasible to use traditional security methods in resource-constrained embedded devices in NoC-based SoCs. It would be ideal if a security mechanism could be implemented without impacting performance. One possible solution is to optimize existing network security mechanisms to fit the performance and power budgets of embedded systems. This thought process has led to prior efforts in securing NoC-based SoCs, which tried to eliminate complex encryption schemes such as AES and replace them with lightweight encryption schemes. Previous work on lightweight encryption proposed smaller block and key sizes, fewer rounds of encryption and other hardware optimizations. For example, Intel's TinyCrypt, a cryptographic library with a small footprint, is built for resource constrained devices. It provides basic functionality to build a secure system with minor overhead. It provides SHA-256 hash functions, message authentication, a pseudo-random number generator which can run using minimal memory, encryption, and the ability to create nonces (random numbers that are used only once during the lifetime of a cryptographic operation) and challenges. Apart from Intel TinyCrypt, several researches have proposed other lightweight encryption solutions in the Internet-of-Things (IoT) domain. However, all of these solutions follow traditional encryption methods, which take a key and a plaintext as inputs to produce the ciphertext.

Existing work on anonymous routing (e.g., onion routing, mixnets, dining cryptographers, etc.) involves mobile ad-hoc networks (MANETS) as well as computer and vehicular networks. The main challenge in using these anonymous routing protocols in resource constrained SoCs is that the protocol uses decryption (“peeling the onion”) at each hop leading to unacceptable performance overhead. Optimized anonymous routing protocols in MANETS use an on-demand lightweight anonymous routing protocol that eliminates per-hop decryption. However, the MANETS environment is fundamentally different from an NoC. This work cannot address the unique communication requirements of a NoC and is not designed for task-migration and context switching.

Irrespective of the optimizations, these methods still have complex computations that take several cycles. While computer networks with potentially unlimited resources can accommodate very strong security techniques such as AES encryption and onion routing, utilizing them in resource constrained NoCs can lead to unacceptable overhead. Indeed, in resource constrained systems like NoCs, security and performance are often a trade-off. But thus far, no security mechanism has achieved an optimal balance between security and performance.

Here, a lightweight encryption and anonymous routing protocol is described that uses a novel secret-sharing-based mechanism to securely transfer data in an NoC-based SoC. This routing protocol, anonymous routing for NoCs (ARNoC) obviates the need for traditional encryption methods without compromising the security guarantees of traditional network security methods. Packets can be changed at each hop of the NoC, so that the complete packet can be constructed at the destination. Therefore, an eavesdropper along the routing path cannot recover the plaintext of the intended message. The data in these messages can be secured using a few addition and multiplication operations for encryption. This leads to a lightweight solution for secure communication that eliminates the need for complex cryptographic operations that cause significant performance overhead. Experimental results demonstrate that ARNoC is lightweight compared to existing encryption methods as well as traditional anonymous routing methods such as onion routing. Thus, ARNoC addresses the trade-off between security and performance by achieving the level of security provided by encryption and anonymous routing without the decreased performance that traditionally accompanies those methods.

One way that ARNoC can achieve this level of security is by adapting a secret sharing approach known as Shamir's secret sharing to the NoC environment. Shamir's secret sharing is based on a property of Lagrange polynomials known as the (k, n) threshold. A secret M can be broken into n shares, and M can only be recovered if at least k (k≤n) shares are retrieved. The knowledge of fewer than k shares leave M unknown. Lagrange polynomials meet this property when k=n. A Lagrange polynomial can be comprised of some k points (x₀,y₀), . . . , (xₖ₋₁,yₖ₋₁) where xᵢ≠xⱼ (0≤i,j≤k−1). A unique polynomial L(x) of degree k−1 can be calculated from these points:

$$\begin{matrix}L ( x ) = {\sum }_{j = 0}^{k - 1} {l}_{j} ( x ) \cdot {y}_{j} \\ where & ( 1 ) \\ {l}_{j} ( x ) = {\prod }_{i = 0 , i \neq j}^{k - 1} \frac{x - {x}_{i}}{{x}_{j} - {x}_{i}} & ( 2 )\end{matrix}$$

L(x) is an interpolated Lagrange polynomial, and lⱼ(x) is a Lagrange basis polynomial. Any attempt to reconstruct the polynomial L(x) with fewer than k points or with incorrect points will result in an incorrect polynomial with wrong coefficients, a wrong degree, or both.

To share a secret using this method, a random polynomial of degree k−1 can be chosen. The random polynomial can take the form L(x)=a₀+a₁x+a₂x²+ . . . +aₖ₋₁x^{k-1}. The shared secret M can be set such that a₀=M, and all other coefficients a₁, a₂, . . . , aₖ₋₁ can be chosen randomly. Then a calculation at x=0 can yield the secret (M=L(0)). In this case, k points on the curve for L(x) can be chosen at random and distributed to multiple parties together with their respective lⱼ(0) values—the Lagrangian coefficients. To retrieve M, all of the parties can share their portions of the secrets. Once all k points and lⱼ(0) coefficients are combined, the secret can be computed as:

$$M = {\sum }_{j = 0}^{k - 1} {l}_{j} ( 0 ) \cdot {y}_{j} \qquad ( 3 )$$

This method makes it easier to compute M without having to recalculate each lⱼ(x).

ARNoC adapts secret sharing using polynomial interpolation to create a lightweight encryption scheme for NoCs. Each router along a routing path in an NoC-based SoC can contribute a portion of a message such that the message changes at each router, and only the destination receives the entire message. By utilizing secret sharing based on polynomial interpolation, ARNoC obviates the need for complex cryptographic operations to encrypt messages. A forwarding node can simply compute low-overhead addition and multiplication operations to hide the contents of the message. As the message passes through the routing path, its appearance is changed at each node, which makes the message's content and route safe from eavesdropping and internal. As a result, ARNoC achieves better performance and energy efficiency.

ARNoC can preserve the security of data transferred between nodes. When discovering a routing path, each packet can be encrypted such that only the intended recipient can decrypt the packet. And when transferring a secret message, the message can be changed at each hop such that the complete secret message can be recreated at the destination. This ensures that any potentially malicious intermediate nodes cannot recover the original message.

ARNoC can also preserve the anonymity of nodes in the NoC. An intermediate node on the routing path can detect neither the source nor the destination of a packet. ARNoC hides both source and destination information from these intermediate nodes, making packets untraceable. Launching attacks on encrypted data passing through a given router becomes much more difficult when the packets are untraceable and their origins are unknown.

In addition to preserving the anonymity of the nodes, ARNoC can also ensure that the path taken by each packet is anonymous. The message can be changed at each hop, so the same message can appear as two completely different messages when passing through two different nodes. In addition, each intermediate node can have routing information only for the preceding and following nodes along the routing path. Therefore, the routing paths of all packets can remain anonymous.

The anonymous routing protocol described herein achieves superior performance compared to traditional anonymous routing methods by eliminating the need for per-hop decryption. Experimental results demonstrate that implementation of existing security solutions on NoC can introduce significant (1.5×) performance degradation, while ARNoC can provide the desired security requirements with minor (4%) impact on performance. The performance improvement of ARNoC comes from the fact that once a routing path has been set up for communication between any two nodes, the overhead that results from securely communicating while preserving route anonymity is much less. The notable overhead occurs when the routing path is discovered due to complex cryptographic operations. The intermediate nodes can encrypt and decrypt packets to exchange parameters securely. Yet these complex cryptographic operations can be performed a constant number of times. The majority of the work can be done at the source, which can select points to be distributed among intermediate nodes after constructing a curve, calculate the Lagrangian coefficients of the selected points, and perform several rounds of encryption and decryption. Once the routing path is setup, packets can be forwarded from one router to the other by a simple table look-up. No per-hop encryption and decryption is needed to preserve anonymity. The security of a message can be ensured by changing the original message at each node using a few addition and multiplication operations, which incur significantly fewer extra delays. Because route discovery can happen once during the lifetime of a task (unless context switching and/or task migration occurs), and because there are only a limited number of communications occurring between nodes in an SoC, the cost during of route discovery can be amortized over time. This can lead to a significant performance improvement compared to the traditional methods of encryption and anonymous routing.

Reference will now be made in detail to the description of the embodiments as illustrated in the drawings, wherein like reference numbers indicate like parts throughout the several views.

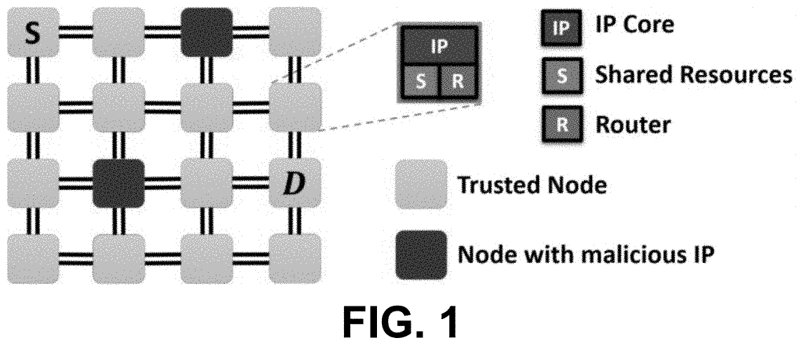

FIG. 1 illustrates an example of an SoC architecture with heterogeneous IP cores integrated into a mesh NoC. FIG. 1 includes source node 103 and a destination node 106 that include trusted IP cores. Also included are malicious nodes 109 that include malicious IPs that may have been obtained from untrusted third-party vendors. In this example, it is assumed only some of the IPs are acquired from untrusted third-party vendors, so all routers may bit be compromised at the same time. Note that while nodes containing malicious IPs are referred to as “malicious nodes,” not all components of a node containing a malicious IP may be malicious.

Malicious nodes 109 integrated on the SoC can compromise the data security of packets that pass through their routers in several different ways. Consider four illustrative examples. First, a malicious node 109 can steal any data in a packet that is sent as plaintext. Second, if a packet's payload is encrypted but the packet's header information is plaintext, a malicious node 109 can accumulate packets sent from the same source node and intended for the same destination node. The malicious node 109 can then launch complex attacks like linear or differential cryptanalysis to reveal the message because the accumulated packets belong to the same communication session. Third, when multiple malicious nodes 109 are present on the same NoC, they can share information and trace messages. Fourth, the router in a malicious node 109 can be compromised so that the malicious node 109 can gather information stored in the router and possibly leak this routing information.

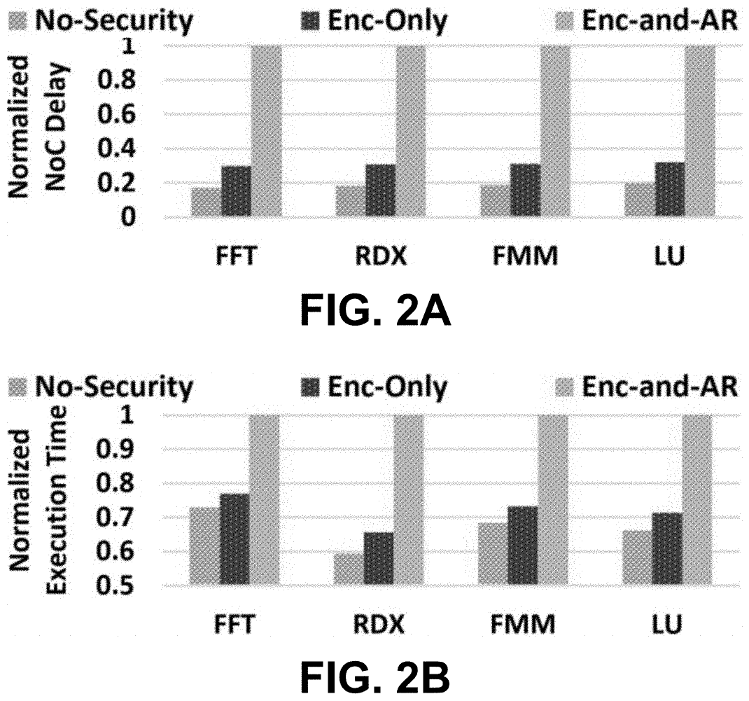

FIGS. 2A and 2B illustrate examples of comparisons of NoC delay and execution time when running real benchmarks while using different levels of network security. To evaluate the impact of implementing security techniques on NoCs, FFT, RADIX (RDX), FMM and LU benchmarks from the SPLASH-2 benchmark suite were run on an 8×8 mesh NoC-based SoC with 64 IPs using the gem5 simulator. Three scenarios in which varying levels of security were implemented on the NoC were considered: No-Security, Encryption-Only, and Encryption-and-Anonymous-Routing. First, in the No-Security scenario, the NoC does not implement encryption or anonymous routing. Second, in the Encryption-Only scenario, the NoC secures data by encrypting the data before sending it into the network, but it does not support anonymous routing. Third, in the Encryption-and-Anonymous-Routing scenario, data encryption and anonymous routing are achieved using onion routing. A 12-cycle delay for encryption/decryption was assumed when simulating Encryption-only and Encryption-and-Anonymous-Routing. When security is considered, No-Security leaves data completely vulnerable to attackers, Encryption-Only secures data using only encryption, and Encryption-and-Anonymous-Routing provides an additional layer of security using anonymous routing in addition to encryption.

During these benchmarks, the total NoC traversal delay for all packets and the execution time were recorded. The values recorded were normalized to the scenario that consumes the most time. Encryption-Only showed a 42% (40% on average) increase in NoC delay and a 9% (7% on average) increase in execution time compared to No-Security. Encryption-and-Anonymous-Routing showed worse results when compared with No-Security. including an 83% (81% on average) increase in NoC delay, which lead to a 41% (33% on average) increase in execution time. In other words, Encryption-and-Anonymous-Routing leads to a performance degradation of approximately 1.5X. The overhead of Encryption-only is caused by the complex mathematical operations, and the number of cycles required to encrypt each packet. In Encryption-and-Anonymous-Routing, onion routing aggravates this overhead because onion routing includes running several rounds of encryption before injecting a packet into the network, as well as decryption at each node. Compared to its impact on NoC delay, added security has less impact on execution time because execution time also includes the time for instruction execution and memory operations in addition to NoC delay. In many embedded systems, a 1.5× performance degradation would be an unacceptable cost for security. Thus, it is not feasible to use traditional security methods like encryption and authentication in NoC-based SoCs.

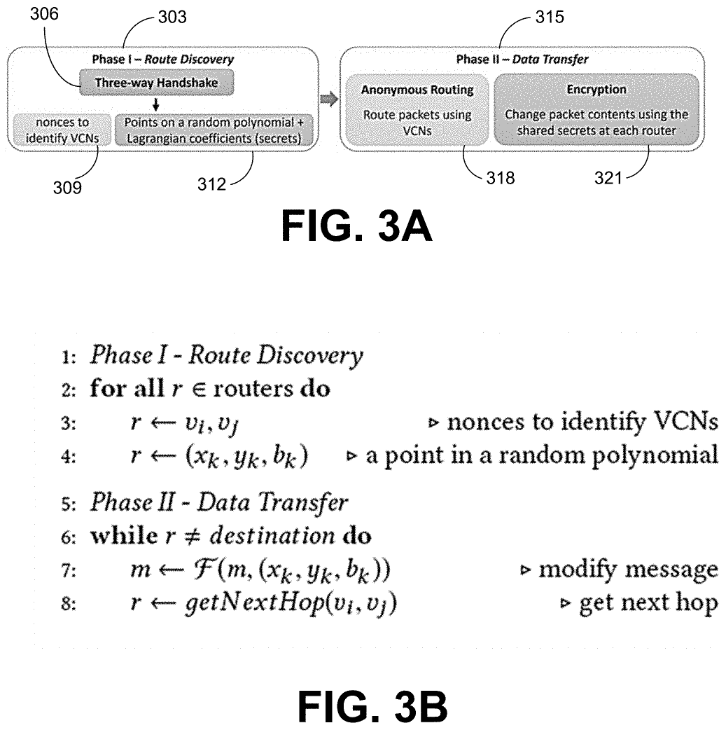

FIGS. 3A-3B illustrate examples of several steps of lightweight encryption and anonymous routing in NoC-based SoCs. FIG. 3A illustrates an example of a flowchart that shows several steps of ARNoC. FIG. 3B illustrates an example of an algorithm implementing several steps of ARNoC. In these examples, to communicate with a destination node, a source node can complete a “route discovery” phase to discover a routing path between the source node and the destination node. Then, the node can complete a “data transfer” phase to transfer a message securely and anonymously to the destination node.

During the route discovery phase, as illustrated at box 303 of FIG. 3A and at lines 1-4 of FIG. 3B, a source node can discover a routing path between the source node and a destination node and distribute parameters among the nodes along that routing path. The route discovered during the route discovery phase may remain the same for the lifetime of a task. In the case of context switching and/or task migration, the route discovery phase may be repeated before transferring data. Each node in the SoC that uses the NoC to communicate with other nodes may follow the same procedure.

In some examples, the route discovery phase can include a “three-way handshake” between a source node and a destination node, as shown at box 306 of FIG. 3A and lines 2-4 of FIG. 3B. The three-way handshake can be used to discover a route between the source node and the destination node. During the three-way handshake, a source node can broadcast a packet to a destination node to initiate route discovery. In response, the source node can receive a packet from the destination node that acknowledges reception of the initial packet. The source node can then send another packet to complete route setup. Each node along the routing path between the source node and the destination node can be assigned one or more parameters that can be used when transferring data. For example, each router can be assigned random nonces to represent preceding and following routers, as shown at box 309 of FIG. 3A and line 3 of FIG. 3B. As another example, each router can be assigned a point on a random polynomial together with its Lagrangian coefficient, as shown at box 312 of FIG. 3A and line 4 of FIG. 3B.

During the data transfer phase, as illustrated at box 315 of FIG. 3A and at lines 5-8 of FIG. 3B, the parameters assigned to each node are used to forward a packet through the routing path discovered during the route discovery phase while hiding contents of the data transfer packet. The packet can routed anonymously using random nonces, which can act as virtual circuit numbers (VCNs), as illustrated at box 318 of FIG. 3A and line 8 of FIG. 3B. When routing a packet, intermediate routers along the routing path can only see the VCNs corresponding to the preceding node and the following node in the routing path, which reveals no information about the source or the destination of the data transfer packet. In some examples, points on a random polynomial and their corresponding Lagrangian coefficients can be encrypted so that each node along the routing path can decrypt only a portion of the packet and change the contents of the packet using that decrypted data, as shown at box 321 of FIG. 3A and line 7 of FIG. 3B. That way, only the destination node can recreate the entire message.

ARNoC can preserve the security of data transferred between nodes because, when discovering a routing path, each packet can be encrypted such that only the intended recipient can decrypt it. The key and nonce exchange can also be secured according to the mechanism described above. Therefore, ARNoC ensures that no intermediate malicious IP can gather enough data to recover plaintext from packets routed through the malicious IP. The security of the secret messages can be preserved by the (k,n) threshold property of Lagrange polynomials. Unless an intermediate node can gather all points distributed among the nodes in the routing path together with their Lagrangian coefficients, the original message cannot be recovered. The message can be changed at each hop such that the complete message can only be recreated at the destination. This ensures that potentially malicious intermediate nodes cannot recover the original message.

ARNoC can also preserve the anonymity of nodes in the network because, when the source node sends the initial packet to initiate the three-way handshake, the source node does not use the identity of the destination. Instead, the source can use the global public key of the destination (PK_{D}) and send a broadcast message on the network. When the initial packet sent by the source node to propagates through the network, each intermediate node can save a temporary public key of its predecessor. This temporary public key can then be used to encrypt data when propagating the packet including destination node's acknowledgement so that unicast messages can be sent to preceding nodes without using their identities. Random nonces and symmetric keys can be assigned to each node, which in turn can be used by the source node packet to distribute points and Lagrangian coefficients to each node. Data transfer can be done by looking up the routing table that consists of the nonces representing incoming and outgoing VCNs. Therefore, the identities of the nodes are not revealed at any point during communication.

In addition to preserving the anonymity of nodes, ARNoC can also ensure that the path taken by each packet is anonymous. First, the message can be changed at each hop. Therefore, even if there are two malicious IPs on the same routing path, information exchange among the two malicious IPs will not help in identifying whether the same message was passed through both of them. The same message appears as two completely different messages when passing through two different nodes. Second, the routing table can contain only the preceding and following nodes along the routing path. A malicious IP that compromises a router can only reveal information about the next hop and the preceding hop. Therefore, the routing paths of all packets can remain anonymous.

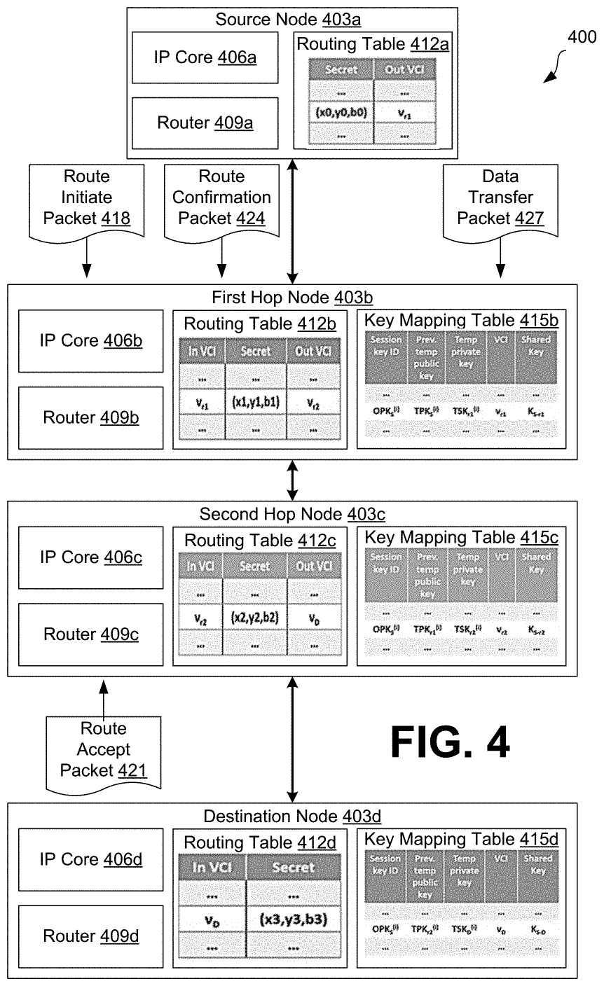

FIG. 4 illustrates an example of an arrangement of several nodes of an NoC-based SoC 400 that can be used to implement ARNoC. In this illustrative example, four nodes 403a-d (collectively “nodes 403”) are used for the purpose of illustration, but any suitable number of nodes can be used to implement ARNoC. The nodes 403 can be integrated in any suitable NoC architecture. Each of the nodes 403 can be bidirectionally linked to one of the other nodes 403 of the NoC-based SoC 400 so that together the nodes 403 may form a bidirectional routing path through which packets can be routed.

Each node 403 can include an IP core 406, a router 409, and a routing table 412. The first hop node 403b, second hop node 403c, and destination node 403d can also include a key mapping table 415. The IP core 406 can represent a reusable functional component of the NoC-based SoC 400 that may be proprietary to a third-party vendor. The router 409 can represent a component of the NoC-based SoC 400 that can be used to route data to and from other nodes in the NoC-based SoC 400.

The nodes 403 can exchange different types of packets during ARNoC, including, for example, a route initiate packet 418, a route accept packet 421, a route confirmation packet 424, and a data transfer packet 427. A route initiate packet can be a packet that is flooded from a source node to a destination node to initialize a communication session. A route accept packet can be a packet sent by the destination node to accept a new connection with the source node. A route confirmation packet can be a packet sent by the source node to distribute configuration parameters to intermediate nodes along a routing path between the source node and the destination node.

The routing tables 412 can represent tables used to determine to which node a packet should be routed. Each entry in the routing tables 412 can include a secret tuple. A secret tuple can represent values that can be used to recreate a secret message. In some examples, a secret tuple can include values xᵢ and yᵢ that represent a point of a polynomial L(x) and a value bᵢ that represents a Lagrangian coefficient of that point. Each entry in the source node's routing table 412a, the first hop node's routing table 412b, and the second hop node's routing table 412c can also include an outgoing VCN. An outgoing VCN can represent a random nonce that identifies a node to which a route confirmation packet 424 is sent. Each entry in the first hop node's routing table 412b, the second hop node's routing table 412c, and the destination node's routing table 412d can also include an incoming VCN. An incoming VCN can represent a random nonce that identifies a node from which a route confirmation packet 424 was received.

The key mapping tables 415 can represent tables used to store various cryptographic keys used to encrypt and decrypt data and map them to their respective nodes. Each entry in a key mapping table 415 can include a session key ID, a previous temporary public key, a temporary private key, a VCN, and a shared symmetric key. The session key ID can represent a public key associated with the source node 403a that changes with each new communication session initiated by the source node 403a. The previous temporary public key can represent a temporary public key for a previous node in the routing path that a node can use to encrypt a portion of a route accept packet 421. The temporary private key can represent a temporary private key that a node can use to decrypt a portion of a route accept packet 421 that was encrypted using that node's temporary public key. The shared symmetric key can represent a symmetric key that is shared between a node and the source node 403a. The source node 403a can use the shared symmetric key to encrypt a portion of a route confirmation packet 424 and that the node can use the shared symmetric key to decrypt that portion of the route confirmation packet 424.

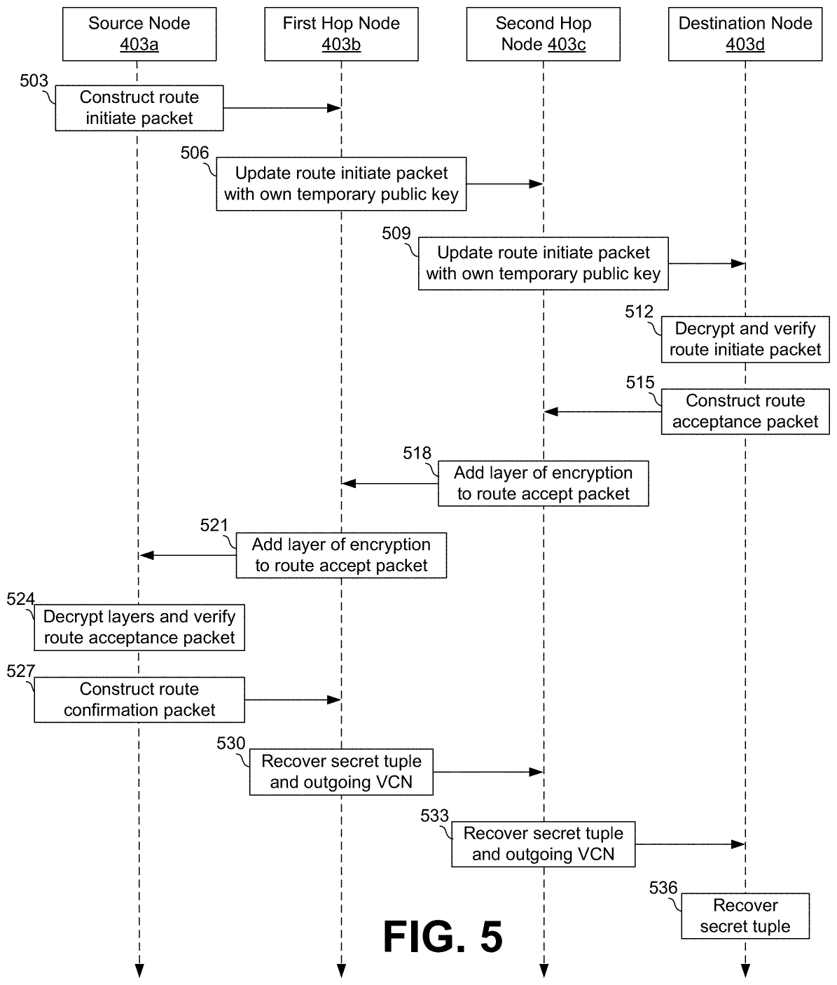

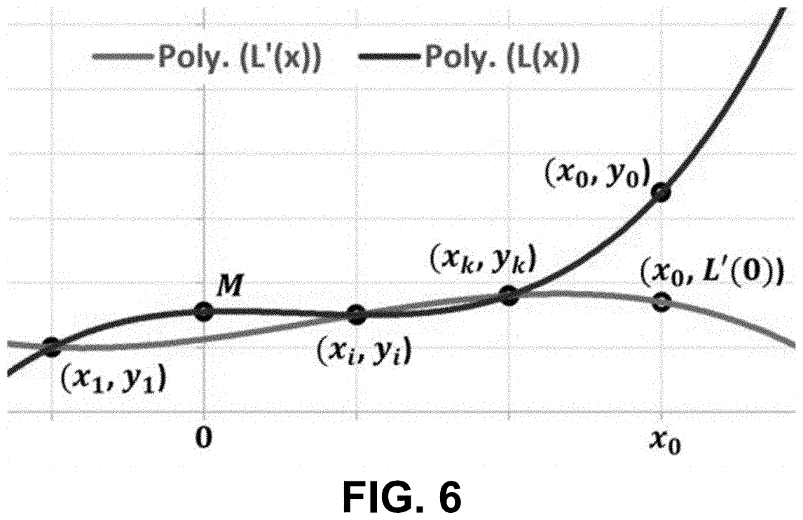

FIG. 6 illustrates an example of the route discovery phase of ARNoC. The example of FIG. 5 uses four nodes to illustrate a three-way handshake to discover a routing path and distribute parameter to nodes along the routing path, but any suitable number of nodes can be used. The keys, parameters, and other values used in this example are illustrative, and any suitable keys, parameters, or other values may be used as can be appreciated. A list of notations used in this example is shown below.
OPK_{S}⁽ⁱ⁾ one-time public key (OPK) used by the source to uniquely identify an RA packet
OSK_{S}⁽ⁱ⁾ the private key corresponding to OPK_{S}⁽ⁱ⁾
ρ a random number generated by the source
PK_{D} the global public key of the destination
SK_{D} the private key corresponding to PK_{D}
TPK_{A}⁽ⁱ⁾ temporary public key of node A
TSK_{A}⁽ⁱ⁾ the private key corresponding to TPK_{A}⁽ⁱ⁾
K_{S-A} a symmetric key shared between S and A
v_{A} a randomly generated nonce by node A
bᵢ Lagrangian coefficient of a given point (xᵢ,yᵢ)
E_{K}(M) a message M encrypted using the key K
   The superscript “i” is used to indicate that the parameter is changed for each packet of a given packet type.

At step 503, the source node 403a (S) can construct a route initiate packet 418. In some implementations, the route initiate packet 418 can initially take the form:

{RI∥OPK_{S}⁽ⁱ⁾∥E_{PK}_{_{D}}(OPK_{S}⁽ⁱ⁾∥ρ)∥TPK_{S}⁽ⁱ⁾} (4)

The first part of the route initiate packet 418 can indicate the type of packet being sent. In this example, the RI included in first section of the route initiate packet 418 can indicate that the packet is a route initiate packet. OPK_{S}⁽ⁱ⁾ (can refer to a one-time public key associated with the source node 403a. Both the source node's public key OPK_{S}⁽ⁱ⁾ and the source node's corresponding private key OSK_{S}⁽ⁱ⁾ can change with each new communication session when a new route initiate packet is constructed. Changing the source node's public key OPK_{S}⁽ⁱ⁾ and the source node's private key OSK_{S}⁽ⁱ⁾ can allow a particular communication session to be uniquely identified using these keys, which are saved in the source node's routing table 412a. ρ can refer to a verification value, which is a number that can be randomly generated by the source node 403a. The verification value p can be concatenated with the source node's public key OPK_{S}⁽ⁱ⁾ and encrypted using the destination node's public key PK_{D} as a global trapdoor to obtain E_{PK}_{_{D}} (OPK_{S}⁽ⁱ⁾∥ρ). Because the destination node's public key PK_{D} is used, only the destination node 403d can open the trapdoor using the destination node's private key SK_{D}. Then, the source node's temporary public key TPK_{S}⁽ⁱ⁾ can be attached to the route initiate packet 418 to show the next node in the routing path the temporary key of the forwarding node.

At step 506, once it receives the route initiate packet 418, the first hop node 403b (r1), can update the route initiate packet 418 with the first hop node's temporary public key TPKᵣ₁⁽ⁱ⁾ and broadcast the updated route initiate packet 418. In some examples, though, the first hop node 403b first can search for the source node's public key OPK_{S}⁽ⁱ⁾ in its key mapping table 415b. If the first hop node 403b finds the source node's public key OPK_{S}⁽ⁱ⁾ in the key mapping table 415b, the route initiate packet may be a duplicate message. Any duplicates can be discarded. Assuming in this example that the route initiate packet 418 is not a duplicate, the first hop node 403b can also attempt to decrypt E_{PK}_{_{D}}(OPK_{S}⁽ⁱ⁾∥ρ) and retrieve the verification value ρ. If the first hop node 403b can successfully decrypt E_{PK}_{_{D}}(OPK_{S}⁽ⁱ⁾∥ρ), then the first hop node 403b is the intended recipient D. Assuming in this example that the first hop node 403b cannot successfully decrypt E_{PK}_{_{D}}(OPK_{S}⁽ⁱ⁾∥ρ), the first hop node 403b can replace the source node's temporary public key TPK_{S}⁽ⁱ⁾ in the route initiate packet 418 with the first hop node's temporary public key TPKᵣ₁⁽ⁱ⁾. Then, the first hop node 403b can broadcast the updated route initiate packet 418, which can now take the form:

{RI∥OPK_{S}⁽ⁱ⁾∥E_{PK}_{_{D}}(OPK_{S}⁽ⁱ⁾∥ρ)∥TPKᵣ₁⁽ⁱ⁾} (5)

The first hop node 403b can also log the source node's public key OPK_{S}⁽ⁱ⁾ and temporary public key TPK_{S}⁽ⁱ⁾ from the received route initiate packet 418, together with the first hop node's temporary private key TSKᵣ₁⁽ⁱ⁾ corresponding to the first hop node's temporary public key TPKᵣ₁⁽ⁱ⁾, in its key mapping table 415b. This information can be used if, for example, the first hop node 403b receives a route accept packet 421 from the destination node 403d.

At step 509, once it receives the route initiate packet 418, the second hop node 403c (r1), can update the route initiate packet 418 with the first hop node's temporary public key TPKᵣ₂⁽ⁱ⁾ and broadcast the updated route initiate packet 418. The second hop node 403c can then discard the route initiate packet 418 as a duplicate if the source node's public key OPK_{S}⁽ⁱ⁾ is found in the key mapping table 415c. Assuming in this example that the route initiate packet 418 is not a duplicate, the second hop node 403c can attempt to decrypt the E_{PK}_{_{D}}(OPK_{S}⁽ⁱ⁾∥ρ) and retrieve ρ. If the second hop node 403c can successfully decrypt E_{PK}_{_{D}}(OPK_{S}⁽ⁱ⁾∥ρ), then the second hop node 403c is the intended recipient D. Assuming in this example that the first hop node 403b cannot successfully decrypt E_{PK}_{_{D}}(OPK_{S}⁽ⁱ⁾∥ρ), the second hop node 403c can replace the first hop node's temporary public key TPKᵣ₁⁽ⁱ⁾ in the route initiate packet 418 with the second hop node's temporary public key TPKᵣ₂⁽ⁱ⁾. Then the second hop node 403c can broadcast the updated route initiate packet 418, which can now take the form:

{RI∥OPK_{S}⁽ⁱ⁾∥E_{PK}_{_{D}}(OPK_{S}⁽ⁱ⁾∥ρ)∥TPKᵣ₂⁽ⁱ⁾} (6)

The second hop node 403c can also log the source node's public key OPK_{S}⁽ⁱ⁾ and the first hop node's temporary public key TPKᵣ₁⁽ⁱ⁾ from the received route initiate packet 418, together with the second hop node's temporary private key TSKᵣ₂⁽ⁱ⁾ corresponding to the second hop node's temporary public key TPKᵣ₂⁽ⁱ⁾, in its key mapping table 415c. In examples where there are additional nodes in the routing path, this process can continue until the destination node 403d receives the route initiate packet 418.

At step 612, once the destination node 403d (D) receives the route initiate packet 418, the destination node 403d can decrypt E_{PK}_{_{D}}(OPK_{S}⁽ⁱ⁾∥ρ) and verify the route acceptance packet 421. The destination node 403d can decrypt E_{PK}_{_{D}}(OPK_{S}⁽ⁱ⁾∥ρ) using the destination node's private key SK_{D} to retrieve the source node's public key OPK_{S}⁽ⁱ⁾ and the verification value ρ from E_{PK}_{_{D}}(OPK_{S}⁽ⁱ⁾∥ρ). Then, to verify that the route initiate packet has not been tampered with, the destination node 403d can compare the decrypted version of source node's public key OPK_{S}⁽ⁱ⁾ with a plaintext version of the source node's public key OPK_{S}⁽ⁱ⁾. If the two versions of the source node's public key OPK_{S}⁽ⁱ⁾ are different, then the destination node 403d can discard the route initiate packet. In some examples, the destination node 403d can also log the source node's public key OPK_{S}⁽ⁱ⁾ and the second hop node's temporary public key TPKᵣ₂⁽ⁱ⁾from the received route initiate packet 418, together with the destination node's temporary private key TSK_{D}⁽ⁱ⁾ corresponding to the destination node's temporary public key TPK_{D}⁽ⁱ⁾, in its key mapping table 415c.

At step 515, assuming that the two versions of the source node's public key OPK_{S}⁽ⁱ⁾ are not different, the destination node 403d can construct and send a route accept packet 421 (RA), which can initially take the form:

{RA∥E_{TPK}_{ᵣ₂}_{⁽ⁱ⁾}(E_{OPK}_{_{S}}_{⁽ⁱ⁾})(ρ∥v_{D}∥K_{S-D}))} (7)

RA, like RI in the route initiate packet 418, can indicate that the packet is a route accept packet 421. The destination node 403d can generate a random nonce, v_{D}, to serve as a VCN for the destination node 403d. The destination node 403d can also generate a randomly-selected key K_{S-D} that can act as a shared symmetric key between the source node 403a and the destination node 403d. The destination node 403d can store the destination node's VCN v_{D} and the destination node's shared symmetric key K_{S-D} in its key mapping table 415d. The destination node 403d can make an entry in its routing table 412d indexed by the destination node's VCN v_{D}. A concatenation of ρ, v_{D}, and K_{S-D} can then be encrypted using the source node's public key OPK_{S}⁽ⁱ⁾ so that ρ∥v_{D}∥K_{S-D} can only be decrypted using the source node's private key OSK_{S}⁽ⁱ⁾. Then, E_{OPK}_{_{S}}_{⁽ⁱ⁾}(ρ∥v_{D}∥K_{S-D}) can be encrypted again using the second hop node's temporary public key TPKᵣ₂⁽ⁱ⁾ to obtain E_{TPK}_{ᵣ₂}_{⁽ⁱ⁾}(E_{OPK}_{_{S}}_{⁽ⁱ⁾}(ρ∥v_{D}∥K_{S-D})) The second hop node's temporary public key TPKᵣ₂⁽ⁱ⁾ is used because the second hop node 403c is the node that delivered the route initiate packet 418 to the destination node 403d. In some example, the destination node 403d can retrieve the second hop node's temporary public key TPKᵣ₂⁽ⁱ⁾ from its key mapping table 415d.

At step 518, once the second hop node 403c receives the route accept packet 421, the second hop node 403c can add another layer of encryption to the route accept packet 421 and encrypt the additional layer. The second hop node 403c can decrypt E_{TPK}_{ᵣ₂}_{⁽ⁱ⁾}(E_{OPK}_{_{S}}_{⁽ⁱ⁾}(ρ∥v_{D}∥K_{S-D})) using the second hop node's temporary private key TSKᵣ₂⁽ⁱ⁾. The second hop node 403c can generate a random nonce, vᵣ₂, to serve as a VCN for the second hop node 403c. The second hop node 403c can also generate a shared symmetric key, K_{S-r2}, to be shared with the source node 403a. Both the second hop node's VCN vᵣ₂ and shared symmetric key K_{S-r2} can then be concatenated to E_{OPK}_{_{S}}_{⁽ⁱ⁾}(ρ∥v_{D}∥K_{S-D}) and encrypted using the source node's public key OPK_{S}⁽ⁱ⁾. This encryption can add another layer of encryption to the route accept packet 421 for the source node 403a to decrypt using the source node's private key OSK_{S}⁽ⁱ⁾. The second hop node 403c can store the destination node's VCN vᵣ₂ and shared symmetric key K_{S-r2} in its routing table 412c and key mapping table 415c. The second hop node 403c can then find the temporary public key for the preceding node in the routing path—which in this case is the first hop node's temporary public key TPKᵣ₁⁽ⁱ⁾—from its key mapping table 415c. The second hop node 403c can encrypt E_{TPK}_{_{S}}_{⁽ⁱ⁾}(E_{OPK}_{_{S}}_{⁽ⁱ⁾}(ρ∥v_{D}∥K_{S-D})∥vᵣ₂∥K_{S-r2}) using the first hop node's temporary public key TPKᵣ₁⁽ⁱ⁾. Then, second hope node 403 can send the updated route accept packet 421, which can take the form:

{RA∥E_{TPK}_{ᵣ₁}_{⁽ⁱ⁾}(E_{OPK}_{_{S}}_{⁽ⁱ⁾}(E_{OPK}_{_{S}}_{⁽ⁱ⁾}(ρ∥v_{D}∥K_{S-D})∥vᵣ₂∥K_{S-r2}))} (8)

At step 521, once the first hop node 403b receives the route accept packet, the first hop node 403b can add another layer of encryption to the route accept packet 421 and encrypt the additional layer. The first hop node 403b can decrypt E_{TPK}_{ᵣ₁}_{⁽ⁱ⁾}(E_{OPK}_{_{S}}_{⁽ⁱ⁾}(E_{OPK}_{_{S}}_{⁽ⁱ⁾}(ρ∥v_{D}∥K_{S-D})∥vᵣ₂∥K_{S-r2})) using the first hop node's temporary private key TSKᵣ₁⁽ⁱ⁾. The first hop node 403b can generate a random nonce, vᵣ₁ to serve as a VCN for the first hop node 403b. The first hop node 403b can also generate a shared symmetric key, K_{S-r1}, to be shared with the source node 403a. Both the first hop node's VCN vᵣ₁ and shared symmetric key K_{S-r1} can then be concatenated to form E_{OPK}_{_{S}}_{⁽ⁱ⁾}(E_{OPK}_{_{S}}_{⁽ⁱ⁾}(ρ∥v_{D}∥K_{S-D})∥vᵣ₂∥K_{S-r2}))∥vᵣ₁∥K_{S-r1} and encrypted using the source node's public key OPK_{S}⁽ⁱ⁾. This encryption can another layer of encryption to the route accept packet 421 for the source node 403a to decrypt using the source node's private key OSK_{S}⁽ⁱ⁾. The first hop node 403b can store first hop node's VCN vᵣ₁ and shared symmetric key K_{S-r1} in its routing table 412b and key mapping table 415b. The first hop node 403b can then find the temporary public key for the previous node in the routing path—which in this case is the source node's temporary public key TPK_{S}⁽ⁱ⁾—from its key mapping table 415c. The first hop node 403b can encrypt E_{TPK}_{_{S}}_{⁽ⁱ⁾}(E_{OPK}_{_{S}}_{⁽ⁱ⁾}(E_{OPK}_{_{S}}_{⁽ⁱ⁾}(ρ∥v_{D}∥K_{S-D})∥vᵣ₂∥K_{S-r2})∥vᵣ₁∥K_{S-r1})) using the source node's temporary public key TPK_{S}⁽ⁱ⁾. Then, the first hope node 403b can then send the updated route accept packet 421, which can take the form:

{RA∥E_{TPK}_{_{S}}_{⁽ⁱ⁾}(E_{OPK}_{_{S}}_{⁽ⁱ⁾}(E_{OPK}_{_{S}}_{⁽ⁱ⁾}(E_{OPK}_{_{S}}_{⁽ⁱ⁾}(ρ∥v_{D}∥K_{S-D})∥vᵣ₂∥K_{S-r2})∥vᵣ₁∥K_{S-r1}))} (9)

In examples where there are additional nodes in the routing path, this process can continue until the source node 403a receives the route accept packet 421.

At step 524, once the source node 403a receives the route accept packet, the source node 403a can decrypt the layers of encryption in the route acceptance packet 421 and verify the route acceptance packet 421. The source node 403a can decrypt E_{TPK}_{_{S}}_{⁽ⁱ⁾}(E_{OPK}_{_{S}}_{⁽ⁱ⁾}(E_{OPK}_{_{S}}_{⁽ⁱ⁾}(E_{OPK}_{_{S}}_{⁽ⁱ⁾}(ρ∥v_{D}∥K_{S-D})∥vᵣ₂∥K_{S-r2})∥vᵣ₁∥K_{S-r1})) using the source node's temporary private key TSK_{S}⁽ⁱ⁾. Then, the source node 403a can decrypt, or “peel,” each layer of the remaining encrypted portion of the route accept packet 421 using the source node's private key OSK_{S}⁽ⁱ⁾ to retrieve all the VCNs, shared symmetric keys, and the verification value p. The verification value ρ can be used to verify that the route accept packet 421 came from the correct destination and was not changed during the journey. In some examples, if the source node 403a cannot verify the route accept packet 421, the route accept packet 421 can be discarded.

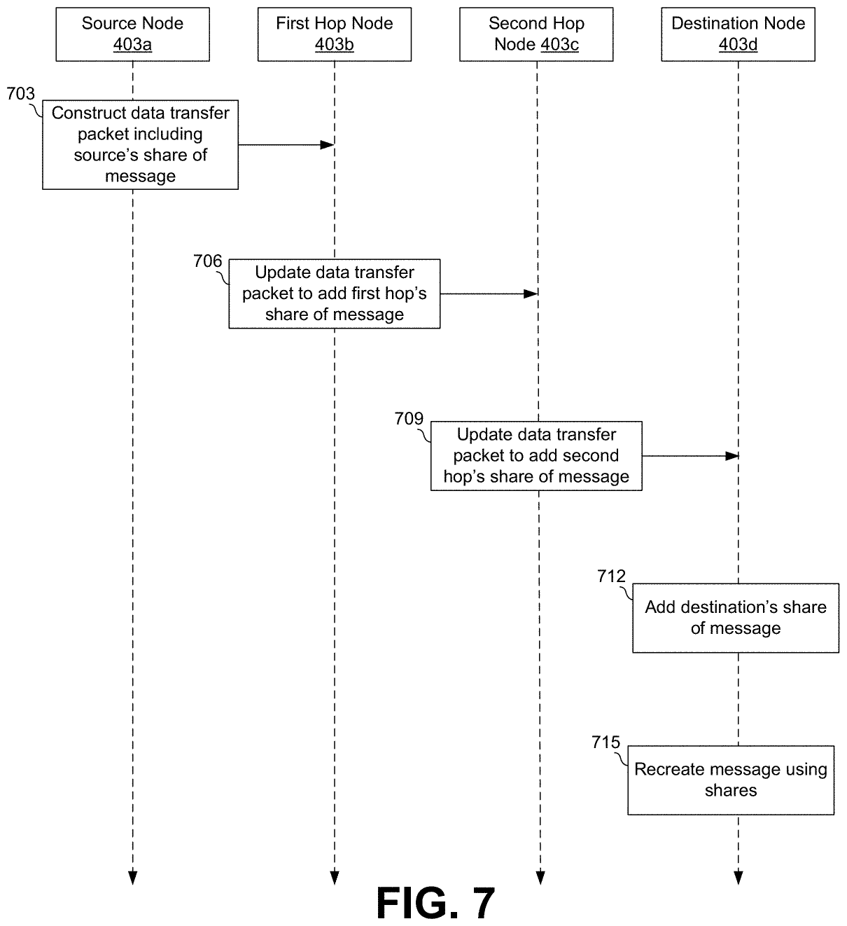

At step 527, the source node can construct a route confirmation packet 424. Assuming that the source node verifies the route accept packet 421, the source node 403a can randomly generate k+1 points (x₀,y₀), (x₁,y₁), . . . (xₖ,yₖ) on a k degree polynomial L(x), as shown in FIG. 7 below. k+1 can refer to the number of nodes in the path from the source node 403a to the destination node 403d. The source node 403a can then use these points to calculate Lagrangian coefficients, b₀, b₁, . . . , bₖ, using:

$${b}_{j} = {\prod }_{i = 0 , i \neq j}^{k} \frac{{x}_{i}}{{x}_{i} - {x}_{j}} \qquad ( 10 )$$

The source node 403a can then construct a route confirmation packet 424 (RC), which can initially take the form:

{RC∥vᵣ₁∥E_{K}_{_{S-r1}}(x₁∥y₁∥b₁∥vᵣ₂∥E_{K}_{_{S-r2}}(x₂∥y₂∥b₂∥v_{D}∥E_{K}_{_{S-D}}(x₃∥y₃∥b₃)))} (11)

Like RA and RI, RC indicates that the packet is a route confirmation packet. The remainder of the route confirmation packet 424 can be layered much like the route accept packet 421. Each layer can contain a VCN v, for each node concatenated with a secret tuple that can be encrypted using the shared symmetric key K_{S-*}, where * corresponds to r1, r2 or D. Each secret tuple can include a point (xᵢ,yᵢ) and a Langrangian coefficient bᵢ that were distributed together with the route accept packet 421. Each pair of VCN v, and shared symmetric K_{S-*} was generated by a respective during transfer of the route accept packet 421. The VCN v, and shared symmetric key K_{S-*} were also stored in the key mapping tables 415 and the routing table 412 in entries indexed by the VCNs v_{*}. Therefore, each node can decrypt one layer of the route confirmation packet 424, store the VCN v_{*} and shared symmetric key K_{S-*} together with the secret tuple, and forward the route confirmation packet 424 on to the next node in the routing path. In some examples, the route confirmation packet 424 can include an intermediate layer for each of the first hop node 403b and the second hop node 403c and a destination layer for the destination node 403d.

At step 530, once the first hop node 403b receives the route confirmation packet 424, the first hop node 403b can recover its secret tuple and an outgoing VCN. The first hop node 403b can determine that the VCN included in the route confirmation packet 424 is the first hop node's VCN vᵣ₁. The first hop node 403b can then decrypt the first layer (an intermediate layer) of the route confirmation packet 424, x₁∥y₁∥b₁∥vᵣ₂∥E_{K}_{_{S-r2}}(x₂∥y₂∥b₂∥v_{D}∥E_{K}_{_{S-D}}(x₃∥y₃∥b₃)), using the shared symmetric key K_{S-r1}, which can already be stored in the key mapping table 415b. By decrypting the first layer of the route confirmation packet 424, the first hop node 403b can recover a secret tuple (x₁,y₁,b₁) and an outgoing VCN vᵣ₂. The first hop node 403b can then update the entry in its routing table 412b indexed by first hop node's VCN vᵣ₁ to include the secret tuple (x₁,y₁,b₁) and the outgoing VCN vᵣ₂.

At step 533, once the second hop node 403c receives the route confirmation packet 424, the second hop node 403c can recover its secret tuple and an outgoing VCN. The second hop node 403c can determine that the VCN included in the route confirmation packet 424 is the second hop node's VCN vᵣ₂. The second hop node 403c can then decrypt the second layer (an intermediate layer) of the route confirmation packet 424, x₂∥y₂∥b₂∥v_{D}∥E_{K}_{_{S-D}}(x₃∥y₃∥b₃) using the symmetric key K_{S-r2}, which can already be stored in the key mapping table 415c. By decrypting the second layer of the route confirmation packet 424, the second hop node 403c can recover the secret tuple (x₂,y₂,b₂) and the outgoing VCN v_{D}. The second hop node 403c can then update the entry in its routing table 412c indexed by the second hop node's VCN vᵣ₂ to include the secret tuple (x₂,y₂,b₂) and w v_{D}. In examples where there are additional nodes in the routing path, this process can continue until the destination node 403d receives the route confirmation packet 424.

At step 536, once the destination node 403d receives the route confirmation packet 424, the destination node 403d can recover its secret tuple. The destination node 403d can determine that the VCN included in the route confirmation packet 424 is the destination node's VCN v_{D}. The destination node 403d can then decrypt the third layer (a destination layer) of the route confirmation packet 424, x₃∥y₃∥b₃, using the shared symmetric key K_{S-D}, which can already be stored in the key mapping table 415d. By decrypting the third layer of the route confirmation packet 424, the destination node 403d can recover the secret tuple (x₂,y₂,b₂). The destination node can then update the entry in its routing table 412d to include the secret tuple (x₂,y₂,b₂).

FIG. 6 illustrates an example of the Lagrangian polynomials L(x) and L′(x) used in lightweight encryption and anonymous routing in NoC-based SoCs. together with the exemplary points on L(x) and L′(x). A routing path discovered during the route discovery phase can be used to anonymously transfer messages from the source node 403a to the destination node 403d. For each communication session, k+1 points were generated on a random curve L(x) chosen by the source node 403a. During the final step of the route discovery phase, the source node 403a kept a secret tuple (x₀,y₀,b₀) for itself and distributed to each node on the discovered routing path a different secret tuple that included a different point, (xᵢ,yᵢ) where (1≤i≤k), and the corresponding Lagrangian coefficient bᵢ.

To send a secret message M to the destination node 403d, the source node 403a can generate a new k degree polynomial L′(x). The new k degree polynomial L′(x) can be defined by the k points distributed to the nodes in the discovered routing path—that is, (xᵢ,yᵢ) where (1≤i≤k), which excludes the point (x₀,y₀) that was retained by the source node 403a—and a new point with an abscissa equal to zero and an ordinate equal to the secret message M (0,M), for a total of k+1 points. This means that L′(0)=M, the secret message. The source node 403a can then create a new point (x₀,y′₀), where x₀ is from the point (x₀,y₀) that was retained by the source node 403a and y′₀=L′(x₀). The source node 403a can also ensure that the point (x₀,y₀) that was retained by the source node 403a is also on the curve L′(x). Each coefficient bᵢ and each point distributed to the nodes along the discovered route, (xᵢ,yᵢ) where (1≤i≤k), can remain unchanged. The secret message M can be recreated using the following equation derived using Equation 3:

$$M = {y}_{0}^{′} {b}_{0} + {\sum }_{i = 1}^{k} {b}_{i} \cdot {y}_{i} \qquad ( 12 )$$

Thus, the destination node 403d can recreate the secret message M once it has all of the points (xᵢ,yᵢ) where (1≤i≤k) and the new point (x₀,y′₀).

FIG. 7 illustrates an example of the data transfer phase of ARNoC. The example of FIG. 7 uses four nodes to illustrate the anonymous routing of a secret message, but any suitable number of nodes can be used. The parameters and other values used in this example are illustrative, and any suitable parameters or other values may be used as can be appreciated.

At step 703, the source node 403a can construct a data transfer packet 427 (DT) that can initially take the form:

{DT∥vᵣ₁∥y′₀b₀} (13)

In the first section of, the data transfer packet 427, DT can indicate that the packet is a data transfer packet. vᵣ₁ can represent the VCN of the next node in the discovered routing patch, which, in this case, is the first hop node 403b. y′₀b₀ is the share of the secret message M that was constructed by the source node 403a. The source node 403a can then send the data transfer packet 427 to the next node in the routing path.

At step 706, once the first hop node 403b receives the data transfer packet 427, the first hop node 403b can add its own share of the message, y₁b₁, to y′₀b₀, the source node's portion of the secret message M in data transfer packet 427. The first hop node 403b can also use its routing table 412b to find the VCN of the next node and replace the incoming VCN with this outgoing VCN in the data transfer packet 427. Therefore, the updated data transfer packet 427 sent by the first hop node 403b can have the form:

{DT∥vᵣ₂∥y′₀b₀+y₁b₁} (14)

At step 709, once the second hop node 403c receives the data transfer packet 427, the second hop node 403c can add its own share of the message, y₂b₂, to y′₀b₀+y₁b₁, the source node's and the first hop node's portions of the secret message M in the data transfer packet 427. The second hop node 403c can also use its routing table 412c to find the VCN of the next node and replace the incoming VCN with this outgoing VCN in the data transfer packet 427. Therefore, the updated data transfer packet 427 sent by the second hop node 403c can have the form:

{DT∥v_{D}∥y′₀b₀+y₁b₁+y₂b₂} (15)

At step 712, once the destination node 403d receives the data transfer packet 427, can add its own share of the message, y₃b₃, to y′₀b₀+y₁b₁+y₂b₂, the source node's 403a, the first hop node's 403b, and the second hop node's 403c portions of the secret message M in the data transfer packet 427. Then, because M=y′₀b₀+y₁b₁+y₂b₂+y₃b₃, the destination node 403d can recreate the secret message M.

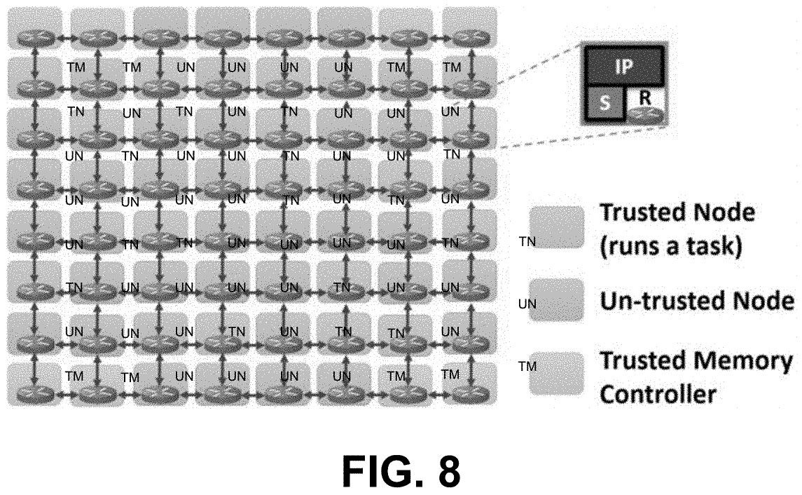

FIG. 8 illustrates an example of an 8×8 mesh NoC-based SoC architecture with 64 cores that includes trusted nodes running tasks and communicating with memory controllers and untrusted nodes that may have malicious IPs. Extending the results shown in FIGS. 2A and 2B, ARNoC was tested on the 8×8 mesh NoC-based SoC using the gem5 cycle-accurate full-system simulator. The NoC was built using the “GARNET2.0” model that is integrated with gem5. Each encryption/decryption is modelled with a 12-cycle delay. Computations related to generating the k points and the random polynomial L(x) is assumed to consume 200 cycles.

ARNoC was tested using 4 real benchmarks-FFT, RADIX, FMM, LU—from the SPLASH-2 benchmark suite and 6 synthetic traffic patterns—(uniform random (URD), tornado (TRD), bit complement (BCT), bit reverse (BRS), bit rotation (BRT), transpose (TPS). Out of the 64 cores, 16 cores were chosen at random. Each one of the randomly-chose cores instantiated an instance of the task. The packets injected into the NoC when running the real benchmarks were memory requests/responses. Eight memory controllers were used to provide the interface to off-chip memory. The eight memory controllers were placed on the boundary of the SoC, which adheres to commercial SoC architectures such as Intel's Knights Landing (KNL).

For synthetic traffic patterns, the destinations of injected packets were selected based on the traffic pattern. For example, uniform random selected the destination from the remaining IPs with equal probability. On the other hand, bit complement complemented the bits of the source address to get the destination address. In this example, the choices made for the experimental setup were motivated by the architecture and the threat model, as well as the behavior of the gem5 simulator. However, ARNoC can be used with any other NoC topology and task/memory controller placement.

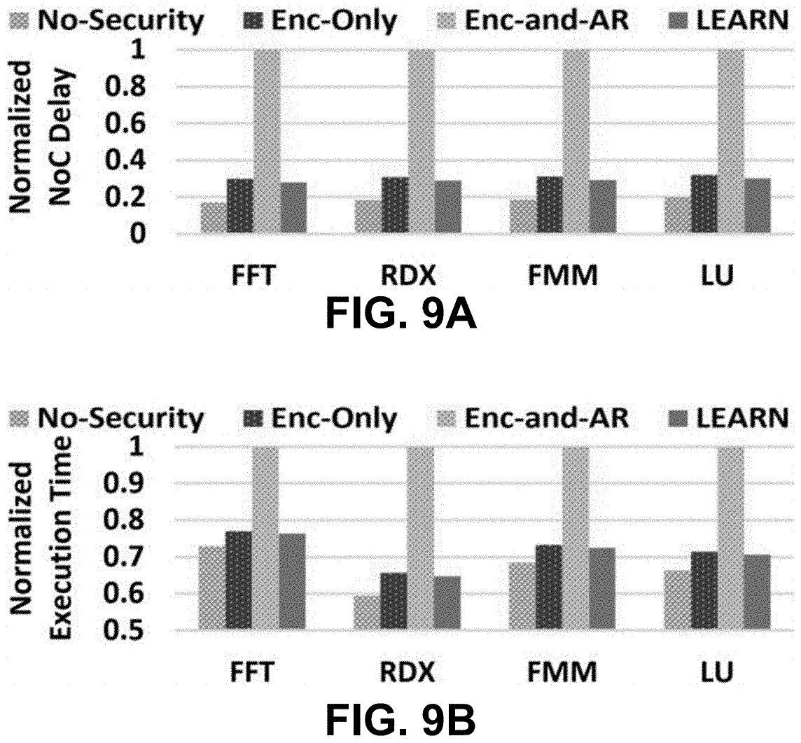

FIGS. 9A-9B illustrate examples of comparisons of NoC delay and execution time when running real benchmarks while using different levels of network security, including No-Security, Encryption-Only, Encryption-and-Anonymous-Routing, and ARNoC. The results from ARNoC are compared against the three scenarios considered in FIGS. 2A and 2B. Compared to the No-Security scenario, ARNoC consumes 28% more time (27% on average) for NoC traversals (NoC delay), which results in only a 5% (4% on average) increase in total execution time. Compared to Encryption-and-Anonymous-Routing, which also implements encryption and anonymous routing, ARNoC improves NoC delay by 75% (74% on average) and total execution time by 37% (30% on average). The results show that the performance of ARNoC is even better than Encryption-only, which provides encryption without anonymous routing. ARNoC can provide encryption and anonymous routing while consuming only a 4% performance overhead compared to an NoC that does not implement any security features.

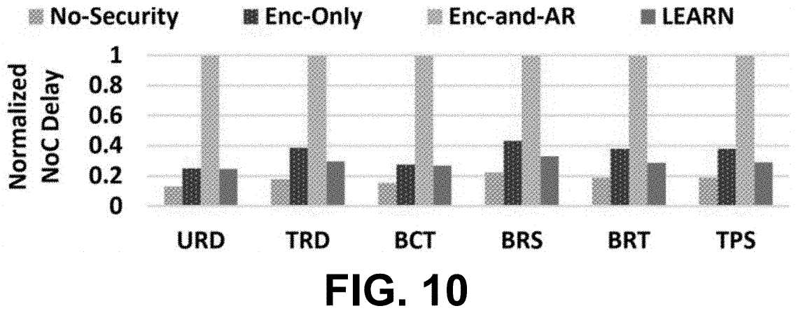

FIG. 10 illustrates an example of a comparison of NoC delay when running synthetic traffic patterns while using different levels of network security, including No-Security, Encryption-Only, Encryption-and-Anonymous-Routing, and ARNoC. Because synthetic traffic patterns only simulate NoC traffic and do not include instruction execution and memory operations, only NoC delay is shown in FIG. 10. Compared to Encryption-and-Anonymous-Routing, ARNoC improves performance by 76% (72% on average).

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for lightweight encryption and anonymous routing, comprising:
identifying, by a source node in a network-on-chip (NoC) based system-on-chip (SoC) architecture, a routing path from the source node to a destination node in the NoC-based SoC architecture, where the routing path comprises the source node, a plurality of intermediate nodes in the NoC-based SoC architecture, and the destination node;
generating, by the source node, a plurality of tuples, a number of tuples in the plurality of tuples being based on a threshold; and
distributing, by the source node, the plurality of tuples to the plurality of intermediate nodes and the destination node.

2. The method of claim 1, wherein identifying the routing path further comprises:
sending, by the source node, a route initiate packet comprising a public key corresponding to the source node, a verification value encrypted together with the public key corresponding to the source node using a public key corresponding to the destination node, and a temporary key corresponding to the source node.

3. The method of claim 2, wherein identifying the routing path further comprises:
receiving, by the source node, a route accept packet comprising a plurality of layers encrypted using a temporary public key corresponding to the source node.

4. The method of claim 3, wherein the plurality of layers comprises:
a destination layer comprising the verification value, a virtual circuit number for the destination node, and a symmetric key corresponding to the source node and the destination node, the destination layer being encrypted using the public key corresponding to the source node; and
a plurality of intermediate layers corresponding to respective intermediate nodes of the plurality of intermediate nodes, each intermediate layer of the plurality of intermediate layers corresponding to a respective intermediate node comprising a virtual circuit number for the respective intermediate node, a symmetric key corresponding to the source node and the respective intermediate node, and a layer corresponding to a previous-hop node, each intermediate layer being encrypted using the public key corresponding to the source node.

5. The method of claim 1, wherein distributing the plurality of tuples comprises:
sending, by the source node, a route confirmation packet comprising:
a plurality of intermediate layers corresponding to respective intermediate nodes of the plurality of intermediate nodes, each intermediate layer of the plurality of intermediate layers comprising a virtual circuit number for a respective intermediate node and data encrypted comprising a tuple corresponding to the respective intermediate node and a layer corresponding to a next-hop node, the data being encrypted using a symmetric key corresponding to the source node and the respective intermediate node; and
a destination layer comprising a virtual circuit number for the destination node and data encrypted using a symmetric key corresponding to the source node and the destination node comprising the tuple corresponding to the destination node.

6. The method of claim 1, wherein generating the plurality of tuples comprises:
generating, by the source node, a plurality of points on a polynomial having a degree equal to one less than the threshold;
calculating, by the source node, a plurality of Lagrangian coefficients based on the plurality of points, each of the plurality of Lagrangian coefficients corresponding to a respective node in the routing path; and
generating, by the source node, the plurality of tuples based at least in part on the plurality of points and the plurality of Lagrangian coefficients.

7. The method of claim 6, wherein, a number of points in the plurality of points is equal to the threshold.

8. The method of claim 6, wherein the plurality of points comprises a point corresponding to the source node, a plurality of points corresponding to respective ones of the plurality of intermediate nodes, and a point corresponding to the destination node.

9. The method of claim 8, further comprising:
sending, by the source node, a data transfer packet comprising a virtual circuit number for an intermediate node and a share of a message corresponding to the source node.

10. The method of claim 9, further comprising:
generating, by the source node, another polynomial having a degree equal to one less than the threshold, the other polynomial being defined by the plurality of points corresponding to the respective ones of the plurality of intermediate nodes, the point corresponding to the destination node, and a point comprising an abscissa equal to zero and an ordinate equal to a value of the message.

11. The method of claim 10, further comprising:
generating, by the source node, a share of a message corresponding to the source node based on a Lagrangian coefficient corresponding to the source node from the plurality of Lagrangian coefficients and a value of the other polynomial at an abscissa of the point corresponding to the source node.

12. The method of claim 9, wherein the data transfer packet is a first data transfer packet, further comprising:
receiving, by an intermediate node from the plurality of intermediate nodes, the first data transfer packet comprising the share of the message corresponding to the source node; and
sending, by the intermediate node, a second data transfer packet comprising the share of the message corresponding to the source node and a share of the message corresponding to the intermediate node.

13. A method for lightweight encryption and anonymous routing, comprising:
receiving, by a destination node in a network-on-chip (NoC) based system-on-chip (SoC) architecture, a route initiate packet comprising a verification value, a public key corresponding to a source node, and a temporary public key corresponding to an intermediate node;
sending, by the destination node, a route accept packet comprising the verification value, a virtual circuit number for the destination node, and a symmetric key corresponding to the destination node;
receiving, by the destination node, a route confirmation packet comprising the virtual circuit number for the destination node and a tuple corresponding to the destination node;
receiving, by the destination node, a data transfer packet comprising the virtual circuit number for the destination node, a share of a message corresponding to the source node, and at least one share of the message corresponding to at least one respective intermediate node; and
recreating, by the destination node, the message using the share of the message corresponding to the source node, the at least one share of the message corresponding to the at least one respective intermediate node, and a share of the message corresponding to the destination node.

14. The method of claim 13, wherein the public key corresponding to the source node and the verification value are encrypted using a public key corresponding to the destination node.

15. The method of claim 14, further comprising:
decrypting, by the destination node, public key corresponding to the source node and the verification value using a private key corresponding to the destination node; and
comparing, by the destination node, a decrypted version of the public key corresponding to the source node and a plaintext version of the public key corresponding to the source node.

16. The method of claim 13, further comprising:
encrypting, by the destination node, the verification value, the virtual circuit number for the destination node, and the symmetric key corresponding to the destination node using the public key corresponding to the source node and the temporary public key corresponding to the intermediate node.

17. The method of claim 13, wherein the tuple corresponding to the destination node is encrypted using the symmetric key corresponding to the destination node.

18. The method of claim 13, wherein the tuple corresponding to the destination node comprises a point corresponding to the destination node on a polynomial having a degree equal to one less than a threshold and a Lagrangian coefficient associated with the point corresponding to the destination node.

19. The method of claim 18, further comprising:
generating, by the destination node, the share of the message corresponding to the destination node based at least in part on the point corresponding to the destination node and the Lagrangian coefficient.

20. The method of claim 13, wherein recreating the message comprises summing, by the destination node, a value of the share of the message corresponding to the source node, a value of the at least one share of the message corresponding to the at least one respective intermediate node, and a value of the share of the message corresponding to the destination node to obtain the message.
